(19) United States
(12) Patent Application Publication
(10) Pub. No.: US 2024/0202765 A1
(43) Pub. Date: Jun. 20, 2024

(54) System and Method for Processing and Adjudicating Coupons

(71) Applicant: Pharmacy Data Network, LLC, St. Joseph, MO (US)

(72) Inventor: Charles D. Welch, JR., St. Joseph, MO (US)

(21) Appl. No.: 18/587,804

(22) Filed: Feb. 26, 2024

Related U.S. Application Data
(63) Continuation of application No. 15/915,722, filed on Mar. 8, 2018, now abandoned.

(51) Int. Cl. G06Q 30/0207; G06Q 40/08

(52) U.S. Cl. CPC G06Q 30/0222; G06Q 40/08

(57) ABSTRACT

A computer-implemented system is provided for adjudicating coupons to be applied to a transaction for goods or services using a computer processor to execute instructions stored in non-transient memory. The system includes a coupon dispensing system configured to receive a coupon request including transaction information for a transaction from a pharmacy management system, identify at least one electronic coupon for the transaction wherein the transaction information satisfies all of the criteria in a business rules set for each of the at least one electronic coupon, and transmit the at least one electronic coupon to the pharmacy management system. The system further includes a coupon processing system configured to receive a coupon claim request including transaction payment information for the transaction from the pharmacy management system. A coupon payment value is determined based on the transaction payment information, and transmitted to the pharmacy management system.

### CROSS-REFERENCE TO RELATED APPLICATIONS

This application is a continuation of U.S. Non-Provisional patent application Ser. No. 15/915,722, filed Mar. 8, 2018. The subject matter of this application is hereby incorporated by reference in its entirety.

### FIELD OF THE INVENTION

This application relates to the field of systems and methods for facilitating coupon processing and adjudication. More specifically, this application relates to a system and method for processing and adjudication of coupon processing based on disparate information in at least a pharmacy computer system and a coupon management system.

### BACKGROUND

Product manufacturers and service providers offer coupons in part to generate an incentive for consumers to purchase their goods or services. Coupons can also be used to advertise and/or create brand recognition for a good or service. Coupons may be provided to consumers in various forms.

Even though providing coupons to consumers has recognized advantages, there are also multiple known issues that make realizing these advantages difficult. These known issues can vary dependent on the particular type of coupon and the type of goods and services being offered. In other words, in addition to known issues with implementing a coupon system and method, different industries may have different requirements and implementation systems that cause additional issues that are unique to that industry. One such industry is the pharmaceutical industry.

Printed coupons are the most commonly recognized form of coupon. Although well known, there are numerous known drawbacks to using printed coupons. In addition to these drawbacks, there are also additional known drawbacks to such use specifically in the pharmaceutical industry.

For example, printed coupons require expenditure on, for example, patient lists to identify recipients, printing, distribution, etc. In another example, most coupons are distributed through magazines, newspapers and other distributed printed media, and consumers typically discover such coupons at home, work, or other areas remote from stores in which the coupons may be redeemed. As a result, coupons distributed in this manner do not typically generate impulse-based sales. Whether or not a particular coupon is effective depends, in large part, on whether a sufficient number of consumers redeem that particular coupon when purchasing a good or service. Thus, the effectiveness of coupons can be measured in terms of redemption rates. It is estimated that the redemption rate for conventional coupons is between two to five percent (2%-5%) and, thus, are not very effective.

In yet another example, the perception of consumers with respect to acquiring and maintaining coupons can also affect the redemption rate. Specifically, some consumers prefer not to deal with the inconvenience of clipping coupons and then saving the coupons until the need for a particular product arises. If the consumer does not have a present need for a product, there is lack of incentive to save the coupon. Another drawback may include that printed coupons distributed by a physician or pharmacist and require the pharmacist or physician to identify patient need for a coupon and thereafter provide the coupon. In this case, the pharmacist needs to process the coupon upon receipt adding to their workflow, etc. Further, since many pharmacies are utilizing electronic scripts, prescriptions are often processed, prepared and priced prior to the patient's arrival to pick up the prescription, such that the patient's presentation of the coupon requires a rework of the processes used to fill the prescription in the first instance.

Electronic vouchers are a different type of coupon that, although not as common as traditional paper coupons, are being used more often. However, these types of coupons have their own drawbacks. For example, electronic vouchers are typically processed at a switch for processing insurance claims. However, responses from switches are often not communicated to patients such that the patient receives the discount without ever being made aware the discount was provided, negating its promotional/goodwill aspects. Further, switches are non-standard across different pharmacies, are difficult to implement in complicated insurance situations such as where primary, secondary, tertiary, etc. insurers make full or partial payments, provide less than all of the information needed for reconciliation by the pharmacy, etc.

Other couponing systems are also being used to attempt to overcome these drawbacks, but these systems also fall short for various reasons. By not being implemented as part of the workflow, built into the pharmacy management systems, implementation is switch dependent and different switches provide different implementations of the couponing process.

What is needed is a system and method for processing coupons for processing and adjudicating coupons that dynamically implement coupon adjudication and application based on evolving defined business rules on disparate systems. What is further needed is such a system and method that is fully automated, with business rules offloaded to a central coupon processing, implementation of the processing of the coupon as part of the workflow, and use of an automated adjudication system so as to minimize workflow disruption and patient confusion and avoid taxing point of sale systems.

### SUMMARY OF THE INVENTION

The preferred embodiments are directed to a system that dynamically implements coupon adjudication to improve coupon redemption rate, improve work flow in filling prescriptions, and facilitate open communication with customers. The invention provides systems and methods for automatically and electronically dispensing coupons determined to be relevant and application to a transaction to be processed in a pharmacy at the time of the transaction.

The invention provides a computer-implemented system for adjudicating coupons to be applied to a transaction for goods or services using a computer processor to execute instructions stored in non-transient memory. The system includes a coupon dispensing system configured to receive a coupon request including transaction information for a transaction from a pharmacy management system, to determine if an electronic coupon for the transaction is available, wherein the transaction information satisfies all of the criteria in a business rules set for each of the at least one electronic coupon, and transmit the corresponding electronic coupon information to the pharmacy management system. The system further includes a coupon processing system configured to receive a coupon claim request including transaction payment information for the transaction from the pharmacy management system and determine a coupon payment value based on the transaction payment information, and transmit the pertinent electronic coupon information to the pharmacy management system.

In one more detailed aspect, the transaction information includes at least patient demographic information, insurance information, and prescription information. In another detail aspect, the criteria in a business rules set includes at least one of a 340B Plan, an NDC, a patient state of residence, a patient age, a number of units being dispensed, a days supplied, a BIN/PCN for primary insurance, a BIN/PCN for secondary insurance, a BIN/PCN tertiary insurance, and a BIN/PCN for quaternary insurance.

In another detail aspect, the transaction payment information includes a coupon adjudication order.

In another detailed aspect, the determined coupon payment value is generated at least in part based on a third-party payment value indicated in the transaction payment information. Further, the determined coupon payment value may be less than the value of the, based on the response from the coupon processing system. The final coupon amount, will be determined by the pharmacy benefits management processing system, initiating the reimbursement to the transacting pharmacy.

Another embodiment of the invention provides a computer-implemented method for adjudicating coupons to be applied to a transaction for goods or services using a computer processor to execute instructions stored in non-transient memory. The method includes receiving a coupon request including transaction information for a transaction from a pharmacy management system, identifying a potential electronic coupon for the transaction wherein the transaction information satisfies all of the criteria in a business rules set for each of the electronic coupons, and transmitting the required electronic coupon information to the pharmacy management system. The method further includes receiving a coupon claim request including transaction payment information for the transaction from the pharmacy management system and determining a coupon payment value based on the transaction payment information, and transmitting the required electronic coupon information to the pharmacy management system.

Yet another embodiment of the invention provides a computer-implemented system for adjudicating coupons to be applied to a transaction for goods or services using a computer processor to execute instructions stored in non-transient memory. The system includes a pharmacy management system configured to generate a coupon request for a transaction, the coupon request including transaction information and a coupon dispensing system configured to receive the coupon request, identify a potential electronic coupon for the transaction wherein the transaction information satisfies all of the criteria in a business rules set for each of the electronic coupons, and transmit the required electronic coupon information to the pharmacy management system The system further includes a coupon processing system configured to receive a coupon claim request including transaction payment information for the transaction from the pharmacy management system and determine a coupon payment value based on the transaction payment information, and transmit the required electronic coupon information to the pharmacy management system and a pharmacy benefits management processing system to process the coupon information.

Other aspects of the invention, besides those discussed above, will be apparent to those of ordinary skill in the art from the description of exemplary embodiments which follows. In the description, reference is made to the accompanying drawings, which form a part hereof, and which illustrate examples of the invention.

### BRIEF DESCRIPTION OF THE DRAWINGS

FIG. 1 is a coupon processing network for coupon processing and adjudication, according to an exemplary embodiment;

FIG. 2 is the coupon processing system of FIG. 1, shown in greater detail according to an exemplary embodiment;

FIG. 3 is a flowchart illustrating a method for generating an eCoupon request to be sent to the coupon processing system of FIG. 1, according to an exemplary embodiment;

FIG. 4 is a flowchart illustrating a method for processing a received response string at the pharmacy management system of FIG. 1, according to an exemplary embodiment;

FIG. 5 is a flowchart illustrating a method for adjudicating the eCoupon thru the pharmacy claims switching system of FIG. 1, according to an exemplary embodiment;

FIG. 6 is a flowchart illustrating a method for processing claims message transmitted from a pharmacy claims switching system to the coupon processing system of FIG. 1, according to an exemplary embodiment;

FIG. 7 is a flowchart illustrating a method for intercommunication of information between the eCoupon processing system of FIG. 2 and the eCoupon dispensing system of FIG. 2, according to an exemplary embodiment; and

FIG. 8 is a flowchart illustrating a method for sending 835 files and paying the pharmacies associated with the pharmacy management systems of FIG. 1, according to an exemplary embodiment.

### DETAILED DESCRIPTION OF THE INVENTION

The system and method described herein facilitates the distribution, processing, and adjudication of coupons providing a discount on the cost of goods or services based on the satisfaction of one or more business rules. The business rules may be specific to the good or service, specific to a consumer, physician, pharmacy, etc., associated with an event, etc. The system and method are implemented by a central system such that the adjudication of a coupon claim may be reconciled across disparate systems, times, goods and services, etc. The system and method will be described herein with reference to pharmaceutical goods and services as an exemplary application. However, one of ordinary skill in the art would easily appreciate that the systems and methods described herein may be applied in a variety of applications to provide discounts on goods and services in various industries.

For example, in the pharmacy industry, claims adjudication is a process used by health insurance companies in processing claims. In processing a claim, a health insurance company receives the claim and begins with an initial processing of the claimant that looks for common errors and missing information. Next, the claim is reviewed against detail items of the insurance payer's payment policies. This review examines the procedural and diagnostic codes, the pharmacy's National Provider Identifier (NPI)/National Council for Prescription Drug Programs (NCPDP) designation, etc. At this point, if the claim passes, it may be paid and remittance advice may be issued to the pharmacy. Some claims are settled based on a manual review by medical claim examiners, which may include interaction with medical professionals and a check of the medical documentation. This review is more likely to be required for unlisted procedures to confirm their medical necessity. Adjudication may result in full payment of the claim, rejection of the claim, or a contracted payment amount.

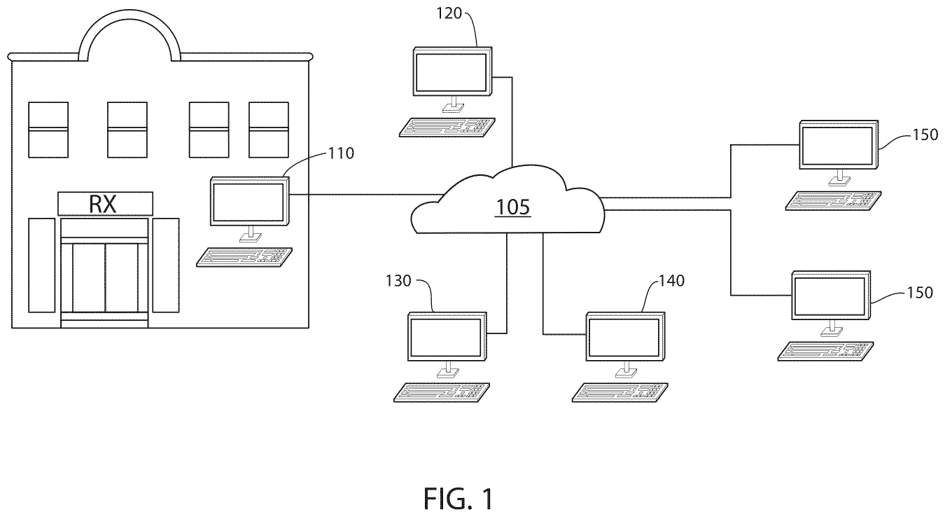

Referring first to FIG. 1, a coupon processing network 100 for coupon processing and adjudication is shown, according to an exemplary embodiment. Computer network 100 includes a coupon processing system 110, a pharmacy management system 120, a pharmacy claims switching system 130, a pharmacy reconciliation system 140 and a plurality of PBM pharmacy benefit manager (PBM) systems 150. A PBM system is, for instance, is a third-party administrator (TPA) of prescription drug programs for commercial health plans, self-insured employer plans, Medicare Part D plans, the Federal Employees Health Benefits Program, and state government employee plans. Intercommunication between the systems in network 100 may be provided using any of a variety of communication systems and methods, such as network 105 as shown, but typically is provided through a secure communication channel over the Internet.

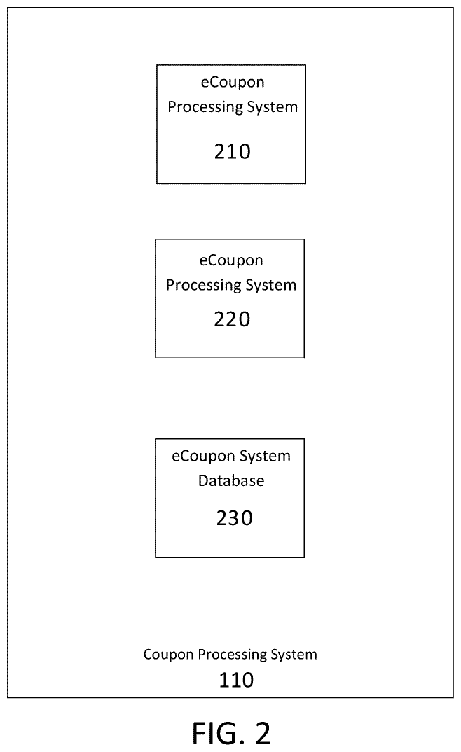

Coupon management system 110, further described below with reference to FIG. 2, may include both a cloud service used for dispensing eCoupons to the pharmacy management system 120, described below, and processors assigned to process eCoupon requests and send the responses back to the pharmacy management system to be implemented in the sale of specified goods or services.

Pharmacy management system 120 is a system operated from within a pharmacy, where patient information and prescription information are entered and stored. This system could be located physically in the pharmacy, in the cloud, or centralized chain system. For example, a pharmacy storefront location may be a single store having a computer implementing the pharmacy management system therein. Alternatively, a pharmacy storefront location may be one of a plurality of such storefronts communicating with a central computing system implementing the pharmacy management system.

System 120 may be configured to gather patient/customer information, such as age, gender, location and other required information based on the rules designed for each coupon type. Coupon type can be determined based on business rules or type of business. Sales data, including item identifiers and/or descriptions is paired with applied benefits data, such as insurance information to be applied to the final sale to the customer. The pharmacy management system 120 may be an independent management system or may be specifically configured for interoperation with the coupon processing system 110. For the implementation specific to the coupon processing system 110, information is bundled together in a specified format to be transmitted to the coupon processing system 110.

Pharmacy claims switching system 130 is a clearing house or processor, typically provided as a cloud service, used for sending prescription insurance claims to be processed by PBMs or other processors. Pharmacy claims switching systems accept D.0 formatted claims for each of the claims entered into the pharmacy management system and determine which pharmacy benefits manager (PBM) to send the individual claim, for processing, this is based on the BIN, PCN and/or Group inside each D.0 formatted claim. A D.0 formatted claim is claim formatted to conform with NCPDP Telecommunications Standard Version D.0, a version of the HIPAA standard for pharmacy claims transactions.

Pharmacy reconciliation system 140 is one or more reconciliation service provider systems, selected by the pharmacy to process remittance files (835 files) sent by the PBM Processor. An “835 file”, or an Electronic Remittance Advice (ERA), is the electronic transaction that provides claim payment information. These files are used by practices, facilities, and billing companies to auto-post claim payments in to their systems. Pharmacy reconciliation systems gather remittance (835) files from PBMs to determine PBM payment information to the actual payment (check) being sent to the pharmacy. Pharmacy systems or switches send claim information to the reconciliation systems to match claims data to the actual payment being sent to the pharmacy.

PBM systems 150 are systems assigned to PBMs or insurance companies to process prescription claims, by BIN/PCN, to send responses back to the Pharmacy Management Systems. PBM systems 150 maintain benefit records for enrollees in one or more benefit plans of a benefit provider, such as a healthcare insurance provider. The benefit records specify various benefit plans that outline benefits that enrollees are eligible to receive. For example, a benefit provided to an enrollee may be that the enrollee's payment for a requested medication is limited to a maximum of twenty dollars. The benefit provider pays the remainder of the purchase amount. The amount paid by the enrollee is referred to herein as the “co-payment.”

The systems shown and described with reference to FIG. 1 may be computer systems configured to include software for the specific applications described above with reference to each system. The computer systems may be computing devices such as a computer or other processing device, such as a personal computer, a server computer, or a mobile processing device. Computing devices includes one or more processors that process software or other machine-readable instructions and includes a memory to store the software or other machine-readable instructions and data. The memory may include volatile and/or non-volatile memory. The computing devices may include one or more interfaces to a communication system to communicate via wireline and/or wireless communications, such as through the Internet, an intranet, an Ethernet network, a wireline network, a wireless network, and/or another communication network. The computing devices may further include a display for viewing data, such as a computer monitor, and an input device, such as a keyboard or a pointing device (e.g., a mouse, trackball, pen, touch pad, or other device), for entering data and navigating through data, including exams, images, documents, structured data, unstructured data, HTML pages, other web pages, and other data.

Referring now to FIG. 2, a coupon processing system 110 is shown in greater detail, according to an exemplary embodiment. Coupon processing system 110 includes an eCoupon dispensing system 210, an eCoupon processing system 220, and a coupon system database 230.

eCoupon dispensing system 210 is configured with customizable coupon dispensing rules sets to be configured based upon each uniquely identifiable item identifier or description. The coupon dispensing rules may be stored in database 230 and processed by a processor of the coupon processing system 110. Processing rules includes determining whether data specific to the rule and received from a pharmacy management system 110 satisfies one or more criteria of the rule for the specific good or service transaction. A rule is considered to be “satisfied” if all of the criteria for the rule are met.

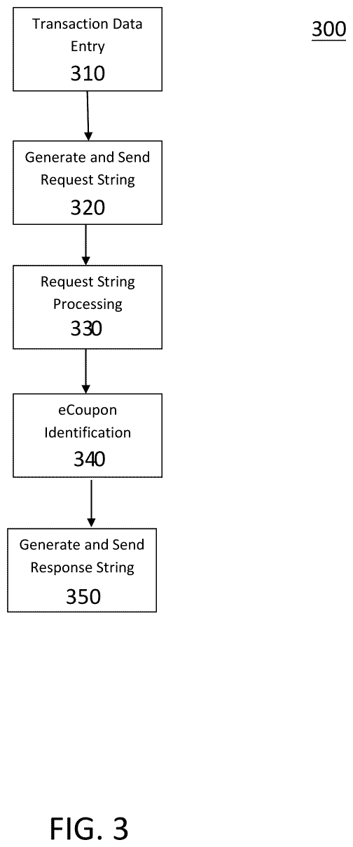

Rules may be bundle together to form rule sets. Rules sets are processed using some or all of the information gathered in the pharmacy management systems 120. Rules sets are assigned to a specific product identifier or description and contain rules for, for example, validating if a coupon should be dispensed, amount of the coupon to be applied, a printable or distributable patient/customer notification. Additional rules and their criteria are provided hereinbelow with reference to FIG. 3.

eCoupon dispensing system 210 stores one or more eCoupon records in database 230. Each eCoupon record includes coupon data that identifies, for example, a corresponding eCoupon, one or more medications eligible for the corresponding eCoupon, and a unique eCoupon identification (ID) code for the corresponding eCoupon.

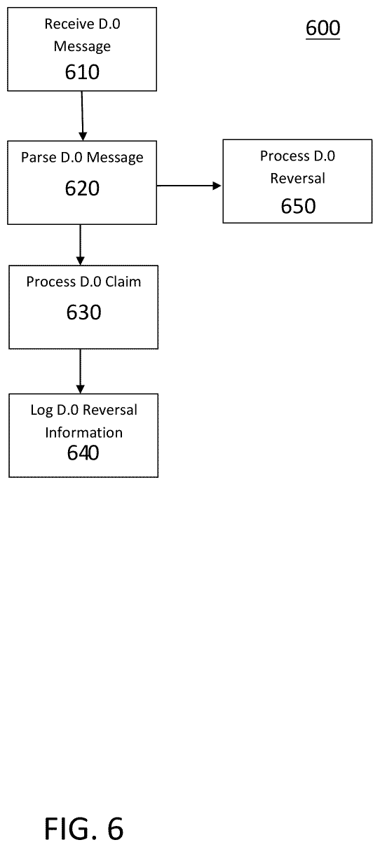

eCoupon processing system 220 is one or more processors assigned to process eCoupon processing requests sent by a pharmacy claims switching system 130 and send a response back to an originating pharmacy management system 120 through the pharmacy claims switching system 130. Exemplary processing requests and methods for processing those requests are discussed in further detail below with reference to FIG. 6.

Referring now to FIG. 3, a flowchart illustrating a method 300 to be implemented by the pharmacy management system 120 for generating an eCoupon request to be sent to the coupon processing system 110 is shown according to an exemplary embodiment. The method includes steps for entering the information in the system and building the eCoupon request. Although the method 300 is shown as including steps in an order to be implemented by the pharmacy management system 120, it should be understood that different steps may be implemented in a different order by different systems to provide the functionality described herein.

The method 300 is configured to be implemented upon initiation of a transaction for the purchase of a good or service. The method is configured to identify data fields needed for the transaction and to connect and communicate this information to the dispensing system. Specifically, information from pharmacy management system 120 is bundled and communicated to the eCoupon dispensing system 210, to be processed by the coupon dispensing system 210 and determine if a coupon should be applied to the selected item based on paired information pertaining to the patient/customer and sales details. Information is received from pharmacy management systems 120 by eCoupon dispensing system 210. All information is validated to be accurate and has the ability to uniquely identify each field contained in the information bundled by the pharmacy management systems 120.

In a step 310, patient, prescription, and third-party information is entered into the pharmacy management system. The data may include all of the information specific to the transaction, including information about the goods or services, information about the transaction, information about the parties in the transaction (including third parties), etc. The information may be obtained during the transaction, may be stored in the pharmacy management system, and/or may be obtained from one or more external sources. For example, in a pharmacy transaction, the transaction information may include a pharmacy national association of boards of Pharmacy (NABP) number (for validation), a patient state of residence, a patient date of birth, a patient gender, a prescription fill number, a national drug code identifier (NDC) of prescription, a number of units being dispensed, a number of days supply, a beneficiary identification number (BIN) for primary insurance, a process control number (PCN) for primary insurance, a BIN for secondary insurance, a PCN for secondary insurance, a BIN for tertiary insurance, a PCN for tertiary insurance, a BIN for quaternary insurance, a PCN for quaternary insurance, a 340b plan (y/n) determination, a long term care (LTC) patient (y/n) determination, and a coupon request.

In a step 320, after all information is entered into the pharmacy management system and just before processing the prescription, pharmacy management system 120 is configured to build an XML request string to be sent to the eCoupon dispensing system 210 with the following fields identified above. In alternative embodiment, the transmitted information may be packaged and transmitted in a variety of formats.

In a step 330, eCoupon dispensing system 210 is configured to receive and parse the transmitted request string to determine a transaction and associated transaction information identified in the request string.

In a step 340, the parsed information is used to identify eCoupons applicable to the request string, if any, using stored business rule sets. For example, in a pharmacy example, applying a rule set to the data in a request string includes applying a plurality of rules to identify any applicable eCoupons. For example, eCoupon dispensing system 210 may initially identify whether an eCoupon exists for the request string based on a search of the eCoupon system database 210. For example, eCoupon dispensing system 210 may attempt to identify an eCoupon based on 340B Plan, an NDC, patient state of residence, a patient age specific, for the number of units being dispensed, for the days supplied, BIN/PCN for primary insurance, for secondary insurance, for tertiary insurance, etc.

In identifying an eCoupon, an item identifier or description is matched to records contained in the eCoupon dispensing system 210. If corresponding item can be matched, the rules assigned to the specific item are processed and a determination is made if a coupon should be dispensed or not. If it is determined that a coupon should be dispensed for this item, coupon information is bundled in the specified format and sent back to the pharmacy management systems 120. Otherwise, if it is determined by no matching items or rules for a specified item, no coupon should be dispensed. The coupon dispensing system will bundle a message, in a pre-determined format and send that message back to the pharmacy management systems 120.

In a step 350, eCoupon dispensing system 210 is then configured to build an eCoupon response message with, for example, information such as an identification of a valid eCoupon (Yes/No), an eCoupon BIN, an eCoupon PCN, an eCoupon Group Code, an eCoupon Name, an eCoupon Max Amount, and an eCoupon Print File. If responding that no eCoupon was identified, a valid eCoupon identifier value is set to No and all following information is left blank. If responding with a valid eCoupon, additional information based on the valid eCoupon rules is included and the Valid eCoupon identifier value is set to Yes and the rest of the fields are populated with proper information. The response string is then transmitted to the pharmacy management system 120 with the proper response message.

Advantageously, automating the checking for available coupons in the pharmacy management system 120 and automatically determining if a valid coupon is available by sending required information to the coupon processing system 110, the need for patients to carry coupons, pharmacies to manually look for coupons and/or manually enter the required information to process a coupon into the pharmacy management system 120, along with the ability to automatically print a patient/pharmacy notification, which is collated with the prescription label generated in the pharmacy, makes the entire process easier for everyone involved and improves the workflow in the pharmacy. The described process allows pharmacies to save money on their prescriptions without the requirement of anyone needing to possess the coupon and/or allowing the pharmacy to track the payment of the coupon.

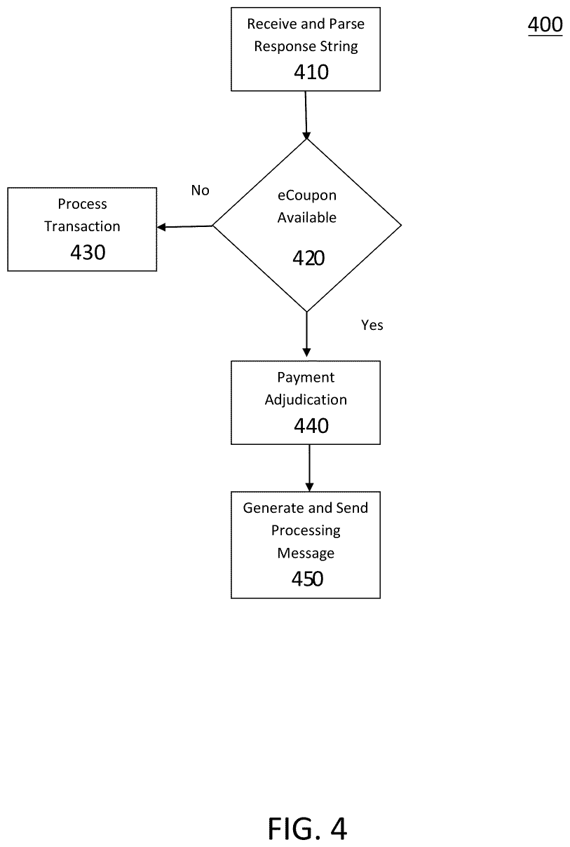

Referring now to FIG. 4, a flowchart illustrating a method 400 for processing a received response string at the pharmacy management system 120 is shown, according to an exemplary embodiment. Method 400 defines a process implemented by the pharmacy management system 120 for receiving the eCoupon response message from the eCoupon dispensing system 210 and steps to automatically process the eCoupon, including, for example, processing an eCoupon in the proper order, determining if the third-party information needs to be inserted into the pharmacy management system 120, steps for processing the eCoupon, etc. Again, although the method 400 is shown as including steps in an order to be implemented by the pharmacy management system 120, it should be understood that different steps may be implemented in a different order by different systems to provide the functionality described herein.

In a step 410, pharmacy management system 120 receives updated coupon information from the eCoupon dispensing system 210 in the eCoupon response message. Pharmacy management system 120 parses the information returned from the coupon dispensing system to determine whether an eCoupon is to be applied to the transaction. For example, a determination may be made whether the BIN/PCN in the eCoupon response message is already in the pharmacy management system 120 database.

In a step 420, a determination is made whether an eCoupon is available. If an eCoupon is not available, the sales transaction is processed normally in a step 430. If coupon is available, eCoupon information contained in the response message is processed by the pharmacy management system 120 to adjudicate or process payments in the proper business order as defined by the information in the eCoupon response message in a step 440. Processing or adjudicating the eCoupon in the proper order may include marking the eCoupon in the adjudication order. The marking may be used later, if the prescription is ever reversed, as described in further detail hereinbelow.

Thereafter, pharmacy management system 120, in a step 450, generates an eCoupon processing message that includes the eCoupon information to be processed electronically by a clearing house or processor, such as pharmacy claims switching system 130.

In a step 460, pharmacy management system 120 is configured to print a receipt or other report, such as a pharmaceutical label. Based on a response to the eCoupon processing message, pharmacy management system 120 determines the final value of the coupon where the switching system provides third-party pay amount that contains this value. If response to the eCoupon processing message indicates that the prescription is being reversed and an eCoupon was attached, pharmacy management system 120 is configured to reverse the eCoupon and remove the eCoupon from the associated prescription. A new eCoupon may then be assigned on the next process. If the coupon processes successfully and the third-party pay amount is >$0.00, the receipt or other report is generated to include a patient notification indicative of the value of the eCoupon benefit.

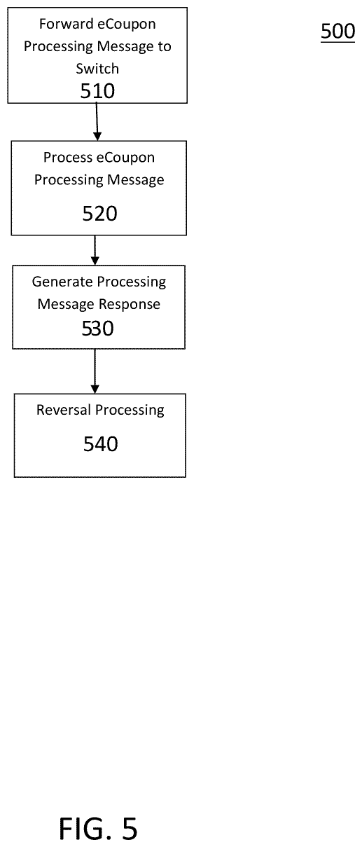

Referring now to FIG. 5, a flowchart illustrates a method 500 for adjudicating the eCoupon thru the pharmacy claims switching system 130 is shown, according to an exemplary embodiment. Method 500 illustrates the steps for processing and adjudicating the information in the eCoupon processing message sent by the pharmacy management system 120 in step 450. Although the method 500 is shown as including steps in an order to be implemented by the pharmacy management system 120, it should be understood that different steps may be implemented in a different order by different systems to provide the functionality described herein.

The eCoupon information may be packaged and transmitted in a standard D.0 formatted message and be transmitted the information to one of a plurality of pharmacy claims switching systems 130. A D.0 message is an update version of the HIPAA standard for pharmacy claims transactions. It is an online, real-time request from the pharmacy to the health plan and a response from the health plan to the pharmacy. The purpose of the D.0 standard is to create a standardized message, which can be sent to switches to then be sent to the pharmacy benefit managers (PBMs) to then determine the insurance payment and patient payment amounts, based on contracts between companies contracting the PBMs to manage their claims and contracts in place between the PBM and the pharmacy. The standard messages sent for these claims, if it is a claim or a claim reversal is a B1 transaction. The B2 transaction is the response from the PBM, back thru the switches to the pharmacy management system 120, to inform the pharmacy of insurance payment amount and patient payment amount (copay). The eCoupon processing message includes transaction payment information including an adjudication order, co-payment information, etc. related to the financial aspect of the transaction based on the application of the eCoupon.

Pharmacy claims switching systems 130 are determined at the point of the dispensing of the coupon information from the coupon processing system 110 and transmitted to the pharmacy management system 120. Thereafter, processing of each eCoupon are implemented in accordance with the coupon's business rules set and returned back to the pharmacy management system 120. Multiple pharmacy claims switching systems 130 can be used in the adjudication process for the coupons listed or maintained in the coupon processing system 110. For each coupon, a processor identifier is assigned to each coupon. For pharmacy processing this would be defined as a specific BIN, PCN and/or group assigned for processing of the coupon and applying payment.

In a step 510, pharmacy claims switching system 130 receives and parses the transmitted eCoupon processing message. The pharmacy claims switching system 130 then forwards the claim to the eCoupon processing system 220 in a step 520, based on the selected BIN/PCN, to be processed and return the needed values, as described below.

Based on the output generated in step 520, pharmacy claims switching system 130 is configured to generate a eCoupon processing response in a step 530. Method 500 may be configured to always send back a successful claim, even if the value of the claim is $0.00. In the case of live transactions with a processor or payer, the goal would be to get a successful claim to process thru the system, even if the amount of the coupon ultimately ends up being $0.00.

As described above, if the eCoupon response contains $0.00 in the third-party payment field, the pharmacy management system 120 will conduct the transaction as if no eCoupon was applied for and not print the patient notification. If the eCoupon response is greater than $0.00 in the third-party payment field, the pharmacy management system 120 will print the patient notification with the eCoupon amount being the value of the third-party payment field. If the response from the clearing house or process is greater than $0.00, an actual coupon amount or patient/customer savings will be applied to the sales transaction. Processing information for the sales transaction is stored in the pharmacy management system 120.

If the value of the claim the is transmitted in 530 represents a reversal, pharmacy management system 120 is configured to, in a step 540, send the reversal of the eCoupon as it exists in the pharmacy management system 120. Once the eCoupon is reversed successfully, pharmacy management system 110 removes the eCoupon information from the prescription. If, based on the eCoupon reversal, the prescription is processed again, method 300 is repeated and a new eCoupon will be dispensed, if available. If the sales transaction is similarly reversed and the item with the applied coupon is returned or put back into stock, the stored information will be used to reverse the coupon and therefore nullify the transaction.

Referring now to FIG. 6, a flowchart illustrates a method 600, implemented by eCoupon processing system 220, for processing claims message transmitted from pharmacy claims switching system 130 to the coupon processing system 130. Although the method 600 is shown as including steps in an order to be implemented by the pharmacy management system 120, it should be understood that different steps may be implemented in a different order by different systems to provide the functionality described herein.

In a step 610, eCoupon processing system 220 receives the eCoupon D.0 message from the pharmacy claims switching system 130. In a step 620, eCoupon processing system 220 parses the message as any other D.0 claim. Specifically, eCoupon processing system 220 determines the proper eCoupon processing rules based on a combination of the BIN, PCN and Group Code. If proper combination has been established, eCoupon processing system 220 determines whether the claim submitted in to the D.0 message is valid in a step 620. If valid (referred to as a B1 message), eCoupon processing system 220 processes the D.0 claim according to associated business rules and respond with proper D.0 response in a step 640. eCoupon processing system 220 further logs the information to be sent to and/or otherwise accessible by eCoupon dispensing system 210 in a step 650.

If the claim is a reversal (referred to as a B2 message), such as if the proper combination of BIN, PCN and Group Code cannot be established, eCoupon processing system 220 prepares a D.0 rejection in a step 660 and transmits the rejection back to the pharmacy management system 120 in a step 670.

Note that one of the issues with previously known systems is the inability of the system, when processing a request, to determine whether one or more generic options/co-pay reductions may be available to the consumer. Given its alternative distribution model, the present system opens the door to facilitate such options by removing the need for the user to be aware of them (for example, via an internet search), and making a request for the same.

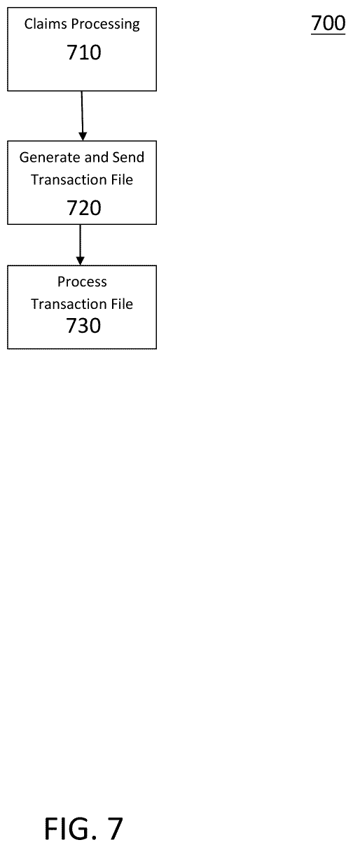

Referring now to FIG. 7, a flowchart illustrates a method 700, implemented by eCoupon processing system 210, for intercommunication of information between the PBM System 150 and the eCoupon dispensing system 210. The transmitted information is used to track actual claims and reconcile with the amount of eCoupons that have been dispensed. All claims data and final patient copay amounts and eCoupon payment amounts from the PBM, need to be reconciled against the distributed coupon amount. As an eCoupon could be sent the pharmacy management system 150 for twenty dollars ($20) the final payment amount for the eCoupon could actually end up being a different amount, like ten dollars ($10). For budgeting reasons, the eCoupon processing system, needs to validate the actual amount of the eCoupon against the recommended amount. Although the method 700 is shown as including steps in an order to be implemented by the pharmacy management system 120, it should be understood that different steps may be implemented in a different order by different systems to provide the functionality described herein.

PBM system 150, assigned to process the specified eCoupon, sends the total transactions processed for a specified date range, back to the eCoupon processing system 220. All claims, either positive or negative, along with the amounts for each item, processor information and item information are sent back to the eCoupon processing system 220. The received information is matched with the initial coupon information to match up the final payment amount for reconciliation and budgeting purposes.

In a step 710, PBM system 150, assigned to process the specified eCoupon, processes claims thru a current day as described above with reference to FIG. 6. At the conclusion of the current day, PBM system 150, assigned to process the specified eCoupon, builds a transaction file to be sent to the eCoupon processing system 220 system in a step 720. In one example, the transaction file may be transmitted via SFTP, in a pipe delimited format. The transaction file includes, in the pipe delineated format, the PDN Processor ID (Assigned to each processor), the BIN, the PCN, the group code, the transaction type (e.g., 1=Billed, 2=Reversed), the third-party pay amount, the transaction date-time, and the full list of approved NABP numbers to be processed.

In a step 730, eCoupon processing system 220 processes the transaction file for audit reasons and to help determine the available budgets, if needed. The processed data from the transaction file may be stored in the processing system database 230.

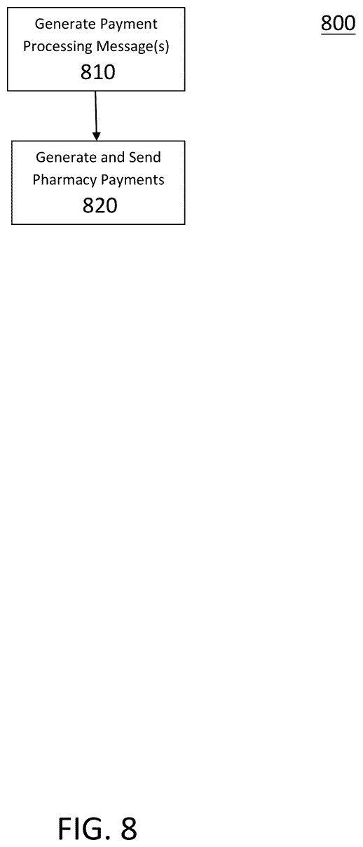

Referring now to FIG. 8, a flowchart illustrates a method 800, implemented by PBM system 150, assigned to process the specified eCoupon, for sending 835 files and paying the pharmacies associated with the pharmacy management systems 120. Although the method 800 is shown as including steps in an order to be implemented by the pharmacy reconciliation system 140, it should be understood that different steps may be implemented in a different order by different systems to provide the functionality described herein.

Pharmacy claims switching systems 130 or pharmacy management systems 120 send reconciliation information back to systems as known in the art, using a typical third-party transaction to pair coupon information with payment information. Thereafter, information from dispensing of coupons and information received from pharmacy claims switching systems 130 or pharmacy management system 120 are used in conjunction to perform statistical analysis of sales trends.

In a step 810, PBM system 150, assigned to process the specified eCoupon, generates payment processing messages sent to the pharmacies associated with the pharmacy management systems 120 pursuant to registered processing standards.

In a step 820, PBM system 150, assigned to process the specified eCoupon, generates payments to the pharmacy for processed eCoupons and corresponding 835s, determines where to send the payments and 835 files, and keeps records for payments sent and where the payments were sent and records for the corresponding 835 files.

Advantageously, coupon processing system 110, implementing the methods shown in FIGS. 3-8, in cooperation with the systems of improves coupon processing and adjudication by reducing the processing requirements and streamlining the work flows of the systems of computer network 100. Given the significant number of coupon processing workflows and the messaging the traditionally has occurred, reducing the amount of messaging and/or the number of steps performed by the individual system described herein will improve the processing speed and reduce network overhead to improve the responsiveness and speed for each coupon processing and adjudication.

This has been a description of exemplary embodiments, but it will be apparent to those of ordinary skill in the art that variations may be made in the details of these specific embodiments without departing from the scope and spirit of the present invention, and that such variations are intended to be encompassed by the following claims.

We claim:

1. A system for obtaining at least one supplemental benefit to be applied to a transaction for pharmacy goods or services using a computer processor to execute instructions stored in non-transient memory, comprising:
a supplemental benefits dispensing system implemented on a first computer and configured to
receive transaction information for a transaction pertaining to filling a prescription or providing services from a pharmacy management system implemented on a second computer,
determine at least one available supplemental benefit in response to the transaction where the transaction information satisfies all of the criteria in a business rules set for each of the at least one supplemental benefit, wherein each of the at least one available supplemental benefits has an unknown final redemption value,
transmit the at least one supplemental benefit to the pharmacy management system including supplemental benefits payment request that includes ordering, building and routing information; and
a supplemental benefit processing system acting as a clearinghouse that is implemented on a third computer and is configured to
receive the supplemental benefits payment request including transaction payment information generated based on an application of all the purchaser's benefits providers to the transaction and the at least one supplemental benefit for the transaction from the pharmacy management system,
transmit the supplemental benefits payment request to a pharmacy benefits payment request adjudicator system implemented on a fourth computer system that will determine an adjudicated supplemental benefits payment value based on the transaction payment information,
receive a response to the supplemental benefits payment request from the payment request adjudicator system, the response including the adjudicated supplemental benefits payment value, and
transmit the adjudicated supplemental benefits payment value to the pharmacy management system to be sold to the purchaser along with notifications given to the purchaser about the application of the supplemental benefits and additional information from the supplemental benefits payer,
wherein the pharmacy management system stores a record of the supplement benefits payment request and returned payment for financial audit and reconciliation purposes, and information about the adjudicated benefits payment is transmitted from the third computer to a reconciliation system implemented on a fourth computer.

2. The system of claim 1, wherein the transaction information includes at least purchaser demographic information, current purchaser benefits information, and prescription information.

3. The system of claim 1, wherein the criteria in a business rules set includes at least one of a drug pricing plan), a national drug code identifier (NDC), a purchaser state of residence, a purchaser age, a number of units being dispensed, a days supplied, a benefits provider identification code (BIN)/process control number (PCN) for primary insurance, a BIN/PCN for secondary insurance, a BIN/PCN tertiary insurance, and a BIN/PCN for quaternary insurance.

4. The system of claim 1, wherein transmitting the at least one supplemental benefit to the pharmacy management system includes transmitting a printable purchaser notification representative of the at least one supplemental benefit provided among other purchaser facing information.

5. The system of claim 1, wherein the at least one supplemental benefit information includes a supplemental benefit adjudication order.

6. The system of claim 1, wherein the adjudicated supplemental benefit payment value is generated at least in part based on a third-party payment value indicated in the supplemental benefit claim transaction payment information.

7. The system of claim 1, wherein the adjudicated coupon payment value is received by the third computer.

8. The system of claim 7, wherein the adjudicated coupon payment value is transmitted to a reconciliation system implemented on a third computer to initiate remittance of the adjudicated coupon payment value to the pharmacy management system.

9. A computer-implemented method for adjudicating coupons to be applied to a transaction for goods or services using a computer processor to execute instructions stored in non-transient memory, comprising:
receiving transaction information for a transaction filling a prescription from a pharmacy management system;
determine at least one electronic coupon that is available in response to the receiving step for the transaction, and that the transaction information satisfies all of the criteria in a business rules set for each of the at least one electronic coupon wherein each of the at least one available electronic coupon has an initial coupon payment value;
transmitting the at least one electronic coupon to the pharmacy management system;
receiving a coupon claim request at a coupon processing system acting as a clearinghouse including transaction payment information generated based on application of the at least one electronic coupon for the transaction from the pharmacy management system; and
determining an adjudicated coupon payment value based on the transaction payment information,
identifying one or more payers based on the determination of the adjudicated coupon payment value,
determining an allocated portion of the adjudicated coupon payment value for each of the one or more payers,
generating one or more coupon processing request for each of the one or more payers, and
transmitting the adjudicated coupon payment value and the coupon processing request from the pharmacy claims switching system to the pharmacy management system for submittal to the payers by the pharmacy management system.

10. The system of claim 9, wherein transmitting the at least one electronic coupon to the pharmacy management system includes transmitting a printable patient notification representative of the electronic coupon.

11. The system of claim 9, wherein the adjudicated coupon payment value is transmitted to a reconciliation system implemented on a third computer to initiate payment of the adjudicated coupon payment value to the pharmacy management system.
